(19) United States
(12) Patent Application Publication
(10) Pub. No.: US 2024/0320604 A1
(43) Pub. Date: Sep. 26, 2024

(54) SYSTEM AND METHOD FOR CALCULATING THE LANDED COST OF IMPORTED PRODUCTS

(71) Applicant: Daniel Lawrence Gardner, Rancho Palos Verdes, CA (US)

(72) Inventor: Daniel Lawrence Gardner, Rancho Palos Verdes, CA (US)

(73) Assignee: Daniel Lawrence Gardner, Rancho Palos Verdes, CA (US)

(21) Appl. No.: 18/603,474

(22) Filed: Mar. 13, 2024

Related U.S. Application Data
(60) Provisional application No. 63/454,655, filed on Mar. 25, 2023.

(51) Int. Cl. G06Q 10/0831; G06Q 10/0834

(52) U.S. Cl. CPC G06Q 10/0831; G06Q 10/08345

(57) ABSTRACT

A system and method are presented that determine the landed cost of a product purchased from an overseas supplier. A Database Management System receives inputs from external systems via Application Programming Interfaces to identify all expenses associated with importing goods, including the unit price of a product, transportation expense, and import customs duties. The system improves on prior art through the conversion of different units of measure associated with import-related transport costs into a single unit of measure and prorating the allocation of transportation charges to an item based on its dimensions and weight. Simultaneous to the allocation of prorated transportation costs to an item, the system identifies and calculates the customs duties assigned to a product by its classification number and country of origin. The novel output of the system is the currency-denominated sum of the unit price of an item, its prorated transportation cost and applicable customs duties.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

The present invention relates generally to the international purchase of goods and specifically, enabling importers to accurately determine the landed cost of products purchased from suppliers in different countries, that are shipped using multiple modes of transportation, and that have unique customs classifications and duties assigned to them upon importation into a country. The applicable U.S. patent classification for this invention is 705/400, covering data processing for cost/price determination.

### (2) Description of the Related Art Including Information Disclosed Under 37 CFR 1.97 and 37 CFR 1.98

The utility of this invention lies in its ability as a Data Base Management System to integrate data from multiple external systems via Application Programming Interfaces with the system platform to identify a product's unit cost, prorate and assign transport-related costs based on a product's weight and dimensions, assign customs duties per a product's customs classification number and country of origin, and generate a summed output that is the complete landed cost of the product.

From a trade-in-goods perspective, the negotiation of product prices between sellers and buyers, combined with the complexities of shipping goods internationally and the need to comply with country-specific customs regulations has made it very difficult for buyers to accurately determine the landed cost of imported products (aka “items”, “goods” or “merchandise”). Defined as the sum of all expenses related to the purchase, transportation and customs clearance of goods into a country, the ability to accurately calculate item-specific landed cost has not been possible for several reasons.

Most importers source a variety of products from different suppliers that are located in more than one country. From a shipping perspective, this means that the importing company must negotiate terms with suppliers that include shipping terms (aka “Incoterms Rules”), transit times and preferred mode of transport that can be via ocean freight, air freight, truck, rail or multi-modal.

The challenge with different shipping modes is that each modality uses a different unit of measure to charge for the various costs associated with goods movement. Because 90% of global trade moves via ocean transport, maritime shipping provides the best illustration of this point. In the world of ocean transportation and depending on the type of service provided, transportation charges can be based on Full Container Load (FCL), Less Than Container Load (LCL), cubic meter, kilo, per ton or by bill of lading. Applicable to all modes of transit, this issue has made it nearly impossible to allocate the transportation component of an item's landed cost as a single, currency-denominated figure.

In addition to the above problem, importers must also account for the customs duties that are levied on imported merchandise. Driven by the regulations and procedures employed by the customs entity of the country of importation, the calculation and allocation of item-specific customs duties has also proved to be quite difficult. This is because depending on a country's customs entity, duties may be assessed by country of origin, the value of the goods, unit of measure and/or preferential duty programs offered by the country of importation.

In spite of these challenges, there is prior art that demonstrates undertakings by individuals and companies to create landed cost solutions. A manual process that utilizes spread sheets, the challenge these parties experience is that the source data for an accurate landed cost calculation is stored in multiple software solutions that include a company-specific enterprise resourcing planning (ERP) system, a transportation management system (TMS), a country-specific customs agency database and data from freight forwarders and customs brokers. The disparate and unconnected nature of these systems has made it exceedingly difficult for importers to digitally calculate the landed costs of an entire product portfolio of imported products.

Until recently, it has not been possible to automatically access data from the above-mentioned sources, thus making the calculation of product-specific landed cost a long, impractical and one-product-at-time undertaking. In addition to the features listed below, the present invention eliminates manual data input and queries by integrating all systems into a Data Base Management System via Application Programming Interfaces (APIs). This improvement over the prior art enables immediate access to the required data that is in turn fed into a landed cost generator that digitally calculates the landed cost of every item in an importer's product portfolio.

Another improvement over the prior art inherent to the invention is that it executes a series of rules-based instructions to standardize the different units of measure used to account for the various elements of the transportation process. Specifically, the system accounts for and standardizes different units of measure used to identify transportation expenses by expressing all costs on a per cubic meter basis. This expression of multiple costs on a per cubic meter basis allows the system to generate a single, currency-denominated figure, thus enabling the proration and assignment of transport costs to an item based on its weight and dimensions.

A significant improvement over the prior art lies in the invention's ability to not only link a product's unit cost and corresponding customs duty, but also calculate, prorate and assign international transportation costs based on an individual product's weight and dimensions. Because importers purchase many different products from overseas suppliers that have a variety of weights, packaging and carton dimensions, it has not been possible to assign accurate transportation costs to an individual item based on the actual weight or space a product occupies in a transport container. It is the combination of the standardization of transport charges in cubic meter form and the subsequent ability to prorate and assign transportation costs to an item, along with systems-based links to unit cost and country-specific customs duties that differentiates the present invention from prior art.

Yet another material difference between the invention and prior art is related to new product introductions (NPIs). Because importers are constantly adding new products to their import portfolio, they need a way to determine a product's landed cost in advance of purchasing goods from overseas suppliers. Historically, landed cost calculation for NPIs have been a combination of estimates, averages and guesswork, the result of which are budgetary errors and product-level financial reporting that require constant adjustments. The new product introduction feature of the invention enables importers to accurately calculate a new product's landed cost in advance of an actual purchase from an overseas supplier, thus enabling accurate financial reporting from the beginning of the product life cycle.

Because the invention integrates multiple data sources and can calculate the landed cost of thousands of different products, yet another improvement over prior art has been achieved. Specifically, the data rich nature of the invention has enabled the creation of a business intelligence (BI) platform that allows importers to analyze all import-related aspects of a product's life cycle. Prior to the present invention, this API-enabled, integrated approach to calculating and managing product-specific landed costs did not exist.

Consistent with the above-mentioned efforts to solve the landed cost determination problem, prior art shows that there are instances of solutions that partially calculate an imported product's landed cost. It should be noted, however, that these solutions have been specific to Business-to-Consumer (B2C) transactions where an individual person goes on-line and seeks to purchase a limited number of items from a single offshore seller. It should also be noted that the calculation of landed cost within these solutions is based on the sum of the unit cost and customs duty applied to an imported product only, without considering the prorated import transportation cost applicable to a product.

An example of prior art related to the present invention is the United States Patent issued to Awaida et al. on Nov. 27, 2012, under U.S. Pat. No. 8,321,356 B2, SYSTEM AND METHOD FOR CALCULATING REAL TIME COSTING INFORMATION. This invention was designed for use as a cost estimate tool for a live, on-line purchase where individual shoppers request a price quotation from a seller prior to making a purchase. It was not designed for Business-to-Business (B2B) multi-product sourcing where the landed cost of a plurality of products must be determined well in advance of importation. Also, as was claimed in the patent, this invention calculates landed cost based on the unit price of the product and applicable customs duties but does not incorporate the cost of international transportation into the landed cost.

Conversely, the novelty, utility and non-obviousness of the present invention lies in its ability to simultaneously identify the unit cost of a plurality of imported products, convert multiple transportation costs into a single unit of measure in the form of a cubic meter, prorate and assign transport expenses to an individual product based on its weight and dimensions, and isolate import duties based on the customs classification and country of origin of the product. This invention improves upon the prior invention by standardizing transport-related units of measure, incorporating prorated transportation costs into the landed cost calculation along with unit cost and customs duty, the sum of which represents the full landed cost of an imported product.

Another example of prior art relevant to the invention is found under patent number 2014/0188747 A1 issued on Jul. 3, 2014 to eBay, Inc. of San Jose, CA entitled, DETERMINING SHIPPING COSTS USING A LOGISTICS TABLE. The essence of this invention as stated in the claims is that it is oriented towards determining the shipping cost of an item in domestic markets where there are no applicable customs duties. This invention does calculate the shipping cost for a single item, as well as for more than one item in scenarios where a buyer purchases multiple products at the same time. However, in neither case does the referenced logistics table prorate transportation costs to specific items based on weight and dimensions. The present invention improves on this capability by calculating landed cost as the sum of a product's unit cost, it prorated transportation expense and applicable customs duty, thus generating the total landed cost of an imported item.

Another example of prior art related to this invention is found in U.S. Pat. No. 11,281,850 B2 issued on Mar. 22, 2022 to the assignee, A9.Com, Inc. of Palo Alto, CA under the name, SYSTEM AND METHOD FOR SELF-FILING CUSTOMS ENTRY FORMS. Related to the topic of calculating an imported product's landed cost and as stated in the claims, this invention enables the preparation of customs entries that allow for the electronic clearance of goods into the commerce of the United States. Designed as a system that extracts import-specific data from multiple sources and populates the fields required for clearance by U.S. Customs & Border Protection, this invention captures data that include product description, country of origin and unit cost to calculate corresponding customs duties. It does not present the output as a landed cost calculation, nor does it include prorated transportation costs for an imported item.

The present invention improves upon the above capability by integrating multiple data sources to calculate an imported products landed cost by summing its unit cost with applicable customs duties and the prorated transportation cost of shipping a product from an origin country to a destination country. BRIEF SUMMARY OF THE INVENTION

The invention provides a system and underlying method for an importer to calculate the landed cost of imported products. Executable through a number of preferred embodiments, the system applies to existing products that are imported regularly, as well as for potential new product introductions. The system also features a business intelligence dashboard that accesses current and historical data to analyze item-level landed costs from multiple perspectives. In all preferred embodiments, the web-based platform calculates a currency-denominated figure that is the sum of a product's unit cost, its prorated transportation expense and the customs duties applied to a product when imported.

More specifically, by example and not limitation, the system includes a database management system which maintains detailed data relating to an importer's enterprise resource planning module, a transportation management system, a customs agency database and freight forwarder and customs broker invoices. The system further includes modules to generate the landed cost of all products in an importer's product portfolio. These modules include a product master data file, a transportation rate matrix & cost converter, a customs duty calculator, a landed cost generator, a new product landed cost generator, a rules repository and a business intelligence dashboard. The system can be located on a cloud server, thus allowing access to users from any internet-enabled device including a smart phone, tablet, desktop or laptop.

In a detailed rendering of an exemplary embodiment, the platform first uses an API to extract data from a user's enterprise management system to compile what is known in the art as a product master data file (PMD). Through the API and housed in the DBMS, item-level details are kept in the PMD file that serve as source data for the unit cost, transportation and customs aspects of the overall landed cost calculation.

Within the same embodiment, importers utilize a transportation management system (TMS) to access all details related to the transportation of imported goods including origin and destination port pairs and different modes of transport such as ocean, air, truck, rail, multi-modal and small parcel. The TMS also houses the prices charged for the origins & destinations (port pairs) that correspond to the countries from which an importer sources products.

The transportation rate matrix & cost converter pulls transport-related data from the transportation management system. Structured as a relational database that links transportation services to individual items in the product master data file by port pair, transport mode and general ledger accounting code, the transportation rate matrix & cost converter standardizes different units of measure related to transport charges on the basis of a cubic meter and sums all the transportation costs related to an item that are found in the TMS. The system then uses pre-determined rules and executable instructions to prorate and assign transport cost to an item that is expressed as a single, currency-based unit of measure.

Within the same embodiment, the customs duty calculator (CDC) receives field-specific data from the PMD file that isolates a product by item name, item number, unit cost, country of origin, classification number and duty rate. The CDC links the unit cost to the duty rate to calculate an output that is the currency-based duty amount levied on an item. Conducted for all items, the result of this calculation is stored in the CDC, as well as sent back to the product master data file where it populates an item-level field entitled, item customs duty.

Because the novelty of the invention is its ability to isolate, standardize and calculate an item's unit cost, prorated transportation and customs fees, the final output of this preferred embodiment is generated by the landed cost generator (LCG). Applied to all products in an importer's portfolio, the LCG is where product-specific instructions are executed to isolate and sum the unit cost of a product, prorated transportation expense and corresponding customs duty to produce the product's landed cost. The output of the rules-based, executable instructions is sent for storage for every item in the product master data file in the corresponding item landed cost field.

In another detailed aspect of an exemplary embodiment, the invention allows an importer to identify, compare and analyze the landed costs of new items that may be imported in the future. Known in the art as a new product introduction (NPI), importers need to conduct financial analysis for new items based on their potential appeal in the marketplace, as well as for the costs associated with their importation.

Unlike existing products in a company's import catalogue, new items are not found in an ERP or product master data file because they have yet to be sourced by the importer. Given this absence of data, the importer can't rely on the system platform to arrive at a landed cost. Notwithstanding this lack of data, the importer still must be able to analyze the same outputs produced by the landed cost generator.

Given this need, the invention features a new product landed cost generator. Capable of outputs identical to those for existing products, the invention allows a user to create an NPI Profile via a graphical user interface (GUI) for a new product. Once the user creates an NPI Profile by inputting product-specific data requirements, the data is fed into the transportation rate matrix and cost converter and customs duty calculator. Identical to the landed cost generator described previously, the new product landed cost generator captures the new item's unit cost, calculates its prorated transportation cost and customs duty, and sums the three data points to generates the landed cost for the new item.

In another detailed aspect of an exemplary embodiment, a business intelligence dashboard interfaces with the DBMS to generate a plurality of financial analysis of budgeted and/or actual landed costs by item, product category or total spend. Designed for users to analyze a landed cost budget for both current and historical data and accessed via a graphical user interface (GUI), this embodiment deploys a combination of existing inputs to the system, as well as additional data sources to provide importers with the facts-based tools they need to manage the financial component of an import program.

To create this capability, the system accesses item-level costs from the user's PMD file that include unit cost, prorated transportation expense and the corresponding customs duty. Conversely, actual costs incurred are fed into the system via two other external data sources; a customs agency database and freight forwarder & customs broker invoices. Specifically, the customs agency database provides actual data on item-level duties paid by an importer during a given period. Freight forwarder & customs broker invoices list the actual transportation and customs clearance charges incurred by an importer during a given period.

By accessing existing modules in the system, as well as the above-mentioned external sources, the business intelligence dashboard receives and lists product-specific cost data by both budgeted and actual cost. This feature allows an importer to compare budgeted vs. actual cost by a product's unit cost, transportation expense and customs duties, thus identifying variances between budgeted and actual outcomes.

In addition to variance analysis, the business intelligence dashboard also allows for stand-alone cost analysis of an item from multiple perspectives. Examples of item-centric analysis include but are not limited to total unit cost spend on an item during a given period, item-level cost break down by mode of transport and total customs duties paid on an item during a given period.

For purposes of summarizing the invention and the advantages achieved over the prior art, the invention allows a user to calculate the landed cost of a plurality of products that are purchased and imported from a plurality of overseas supplier in different countries. A rules-based Database Management System (DBMS) receives inputs from external sources via an Application Programming Interface to identify all expenses associated with importing goods from foreign sellers, including the unit price of a product, international and domestic transportation expenses, and import customs duties.

The DBMS then converts different units of measure associated with import-related transport costs into a single unit of measure expressed as a cubic meter, thus enabling the allocation of transportation charges to an item based on the space or weight that it occupies in a shipping container. Simultaneous to the allocation of prorated transportation costs to an item, the system calculates the customs duties assigned to a product pursuant to its customs classification number and country of origin. Designed to accommodate the importation of existing products from international suppliers, as well as calculate landed cost for potential new product introductions and enable a business intelligence dashboard, the novel output of the system is the currency-denominated sum of the unit price of an item, its prorated transportation cost and applicable customs duties.

All of the embodiments articulated herein are meant to fall within the parameters of the disclosed invention, the novelty of which will become apparent to those practiced in the art as proven in the upcoming detailed description.

### BRIEF DESCRIPTION OF THE SEVERAL VIEWS OF THE DRAWINGS

Embodiments of the present invention are now described, by way of example only, with reference to the following drawings in which:

FIG. 1 depicts a high-level block diagram of the system and method for calculating the landed cost of imported products.

FIG. 2 is a block diagram and corresponding data fields that depict the transfer of item-level data elements from an importer's enterprise resource planning system (ERP) to the product master data file housed in the database management system (DBMS).

FIG. 3 is a block diagram and corresponding list of data points that depict the transfer and calculation of data from a transportation management system (TMS) to the rules-based transportation rate matrix & cost converter (RMCC) and landed cost calculator in the DBMS.

FIG. 4 is a flowchart that depicts the process of data transfer and calculation from a TMS to the transportation rate matrix & cost converter and landed cost generator in the DBMS.

FIG. 5 demonstrates a block diagram and data fields that transfer from the importer's ERP to the product master data file used to calculate rules-based item-level customs duties in the customs duty calculator.

FIG. 6 is a flowchart that depicts the transfer of data from the importer's ERP to the product master data file, the calculation of item-level customs duties in the customs duty calculator and transmission to the landed cost generator.

FIG. 7 is a block diagram of the inputs required to generate item-level landed cost in the landed cost generator and populate corresponding fields in the product master data file.

FIG. 8 is a flowchart that maps the generation of item-level landed cost in the landed cost generator and population of corresponding fields in the product master data file.

FIG. 9 is a user interface of the product master data item profile that receives the sum of item-level unit cost, prorated transport expense and customs duties from the landed cost generator, populates corresponding product master data file fields and publishes an item's true landed cost.

FIG. 10 depicts a list of the potential transportation and customs duty rules that can be housed in the rules repository and applied to landed cost calculations.

FIG. 11 depicts the user interface that publishes the output of the landed cost calculation of a potential new product introduction (NPI).

FIG. 12 is a flowchart that maps the landed cost calculation for a new product introduction using the new product introduction profile and new product landed cost calculator.

FIG. 13 is a block diagram with corresponding data fields that depict data and flows from the product master data file, transportation rate matrix & cost converter, customs agency database and freight forwarder & customs broker invoices to the business intelligence dashboard (BID).

FIG. 14 depicts the data fields in the U.S. Customs Border Protection form 7501 (Entry Summary) that are extracted and sent to the business intelligence dashboard.

FIG. 15 is a flowchart that depicts the process through which data is imported from a customs agency database (U.S. example) into the business intelligence dashboard.

FIG. 16 is a flowchart that depicts the data flows between freight forwarder & customs broker invoices and the business intelligence dashboard.

FIG. 17 depicts the customizable graphical user interface (GUI) in the BID for budgeted vs. actual customs variance analysis for a single item.

FIG. 18 depicts the customizable GUI in the business intelligence dashboard for item-specific full year landed cost spend analysis.

### DETAILED DESCRIPTION OF THE INVENTION

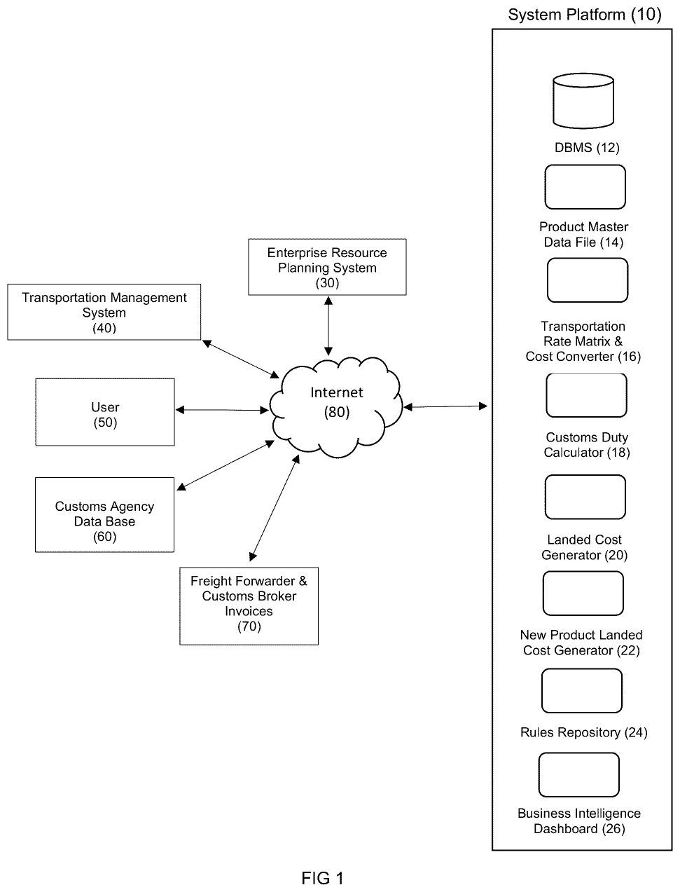

Referring now to the drawings and particularly FIG. 1, there is shown a system platform 10 that provides user 50 with a web-based platform that identifies, extracts, standardizes, calculates and publishes the landed cost associated with importing goods from foreign countries. Within the system platform 10, Application Programming Interfaces are used to continuously import data from multiple external sources into a database management system (DBMS) 12 where all rules-based landed cost instructions are carried out and published.

Throughout this detailed description of the preferred embodiments, user 50 is defined as a company that imports raw materials, work in process and/or finished goods from multiple suppliers located in different countries via several modes of transport (air, ocean, truck, rail, intermodal). Referred to interchangeably as a “user” or “importer”, professionals within the importing organization use system platform 10 to determine, publish and manage the landed cost of all items imported into a country from offshore suppliers and vendors. Within the importer's organization, trade professionals that use and find utility in the invention include product designers, accountants, financial analysts, purchasing managers, purchasing agents, sourcing managers, budget managers, logistics managers, sales & operations planning professionals, inventory managers and senior-level supply chain executives.

There are four external data sources that serve as inputs to system platform 10, beginning with the user's enterprise resource planning (ERP) system 30. It is within the user's ERP that item-specific details are housed including item name, description, item number, supplier details, unit cost, country of origin and customs classification number. The second data source is the user's transportation management system (TMS) 40 that stores information specific to all negotiated transportation rate agreements with carriers that provide ocean, air, truck, rail, intermodal and small parcel services. The third data source is a customs agency database 60 that holds information related to an importer's actual real-time import activities with details on product description, customs classification number, country of origin, entered value and customs duties paid. The fourth data source is freight forwarder & customs broker invoices 70 that itemizes actual real-time charges incurred for transportation services related to the importation of goods.

With reference to FIG. 1 and turning to the database management system (DBMS) 12, the DBMS is comprised of seven modules that execute, publish, store and/or share the landed cost of all items in an importer's product portfolio. The product master data file (PMD) 14 houses data imported from the user's ERP 30, as well as receives and stores the outcome of each item's landed cost calculation from the landed cost generator 20. The transportation rate matrix & cost converter (RMCC) 16 imports transportation-related data from the transportation management system 40 that is used to standardize, sum, prorate and assign costs to a product based on product weight and dimensions, port pair and mode of transport. The customs duty calculator 18 uses data from product master data file 14 to calculate customs duties assignable to a product.

Continuing with FIG. 1 and within database management system 12, the landed cost generator 20 receives the unit cost from the product master data file 14, the prorated item-level transportation cost from the transportation rate matrix & cost converter 16 and the applicable customs duty from the customs duty calculator 18 to sum and publish the landed cost for all items in an importer's product portfolio. In addition to the customs duty calculator 18, the database management system 12 also features a new product landed cost generator 22 that is used by importers to calculate the landed cost of a new item that has yet to be imported.

The rules repository 24 housed in database management system 12 holds the pre-determined criteria that users assign to both the transportation and customs elements of a landed cost calculation. Applicable to both the transportation rate matrix & cost converter 16 and the customs duty calculator 18, these rules enable an accurate summation of a product's landed cost by including parameters on the use of shipping terms, container size, minimum container utilization requirements and the proration of non-item-specific customs fees. The last module in system platform 10 is the business intelligence dashboard 26 that enables the creation and display of Key Performance Indicators that are derived from actual and historical data imported from the landed cost generator 20, customs agency database 60 and freight forwarder & customs broker invoices 70.

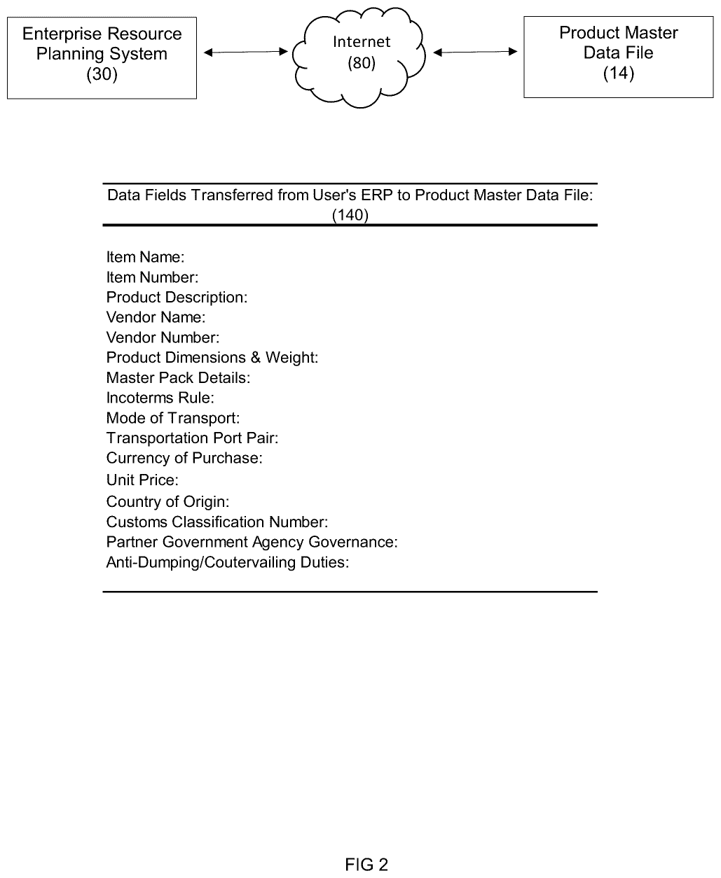

The core functionality of system platform 10 is based on the ability to import data from external sources into the modules that constitute database management system 12 and calculate a landed cost that is the sum of an item's unit price, prorated transportation expense and customs duties. For the preferred embodiment that generates landed costs for an existing portfolio of products that are sourced by an importer from foreign suppliers, the process of converting multiple data points into a product-specific landed cost begins with FIG. 2 and the transfer of item-level data from the importer's enterprise resource planning system 30 to product master data file 14. The specific data fields imported into the product master data file 14 from the enterprise resource planning system 30 are depicted as data fields transferred from user's ERP to the product master data file 140.

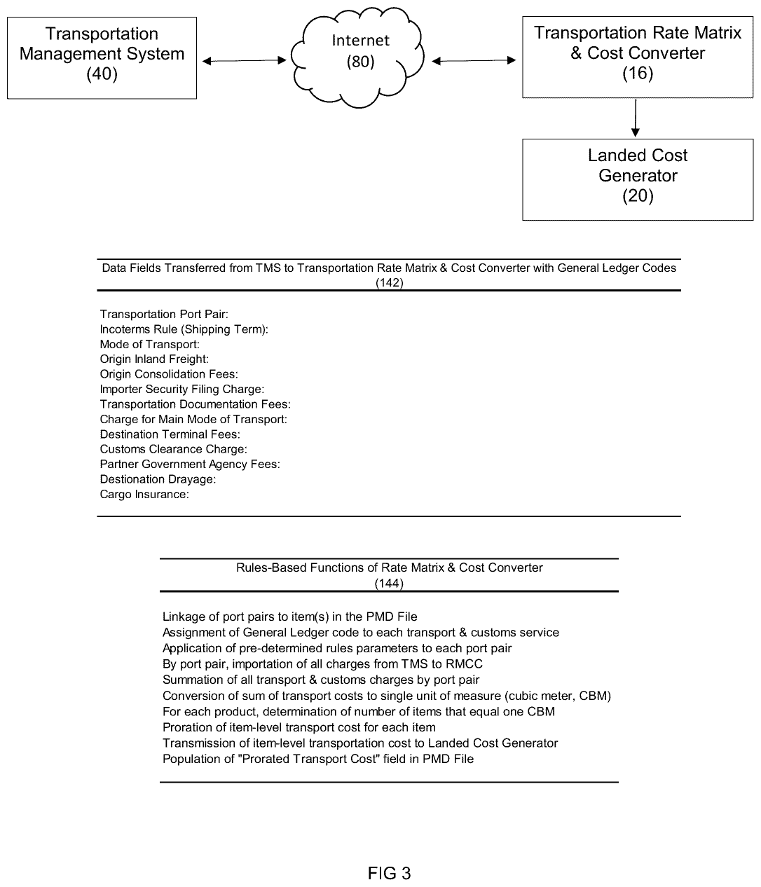

The data points that are imported from the enterprise resource planning system 30 into product master data file 14 serve as the inputs that are used by other modules in system platform 10 to execute a plurality of rules-based, instruction-driven functions. Upon system validation of the transfer of all data to product master data file 14, 102, 202 the aforementioned data fields are shared with, and are permanently linked to transportation rate matrix & cost converter 16, customs duty calculator 18 and landed cost generator 20. Described in detail in upcoming sections of this embodiment in FIGS. 3, 4, 5, 6 and 9, the outputs of these modules are sent back to the product master data file 14 and populate fields entitled, unit cost, prorated transport cost, item customs duty and item landed cost.

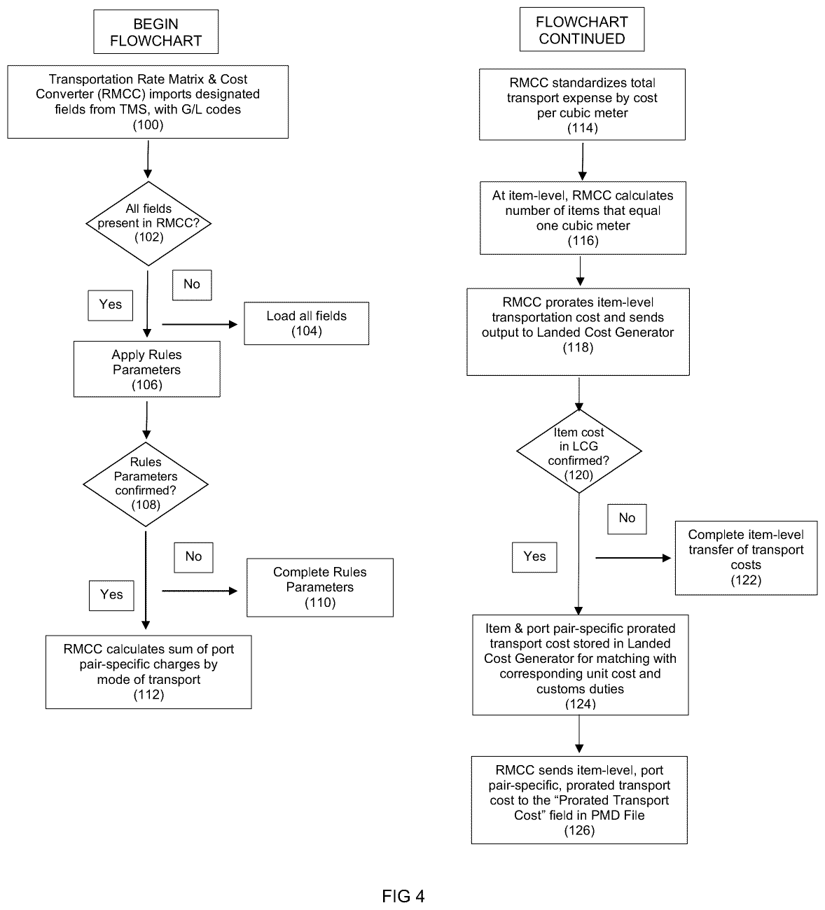

Continuing with the process of converting data inputs into an item-level landed cost figure, FIG. 3 is a block diagram and list of data fields where designated fields in the transportation management system 40 are imported into the transportation rate matrix & cost converter 16 and segregated by port pair and corresponding item number. This segregation of data by port pair and item number in the transportation rate matrix & cost converter 16 goes to the core of the relational nature of database management system 12 because every item in an importer's portfolio must have an item number and it must be shipped from/to a specific origin and destination port (i.e., port pair). Because item numbers and port pairs are listed in both product master data file 14 and transportation rate matrix & cost converter 16, the system can accurately calculate, assign, store and share prorated transportation costs at the product level.

Whereas the executable instructions for FIG. 3 are explained in the rules-based functions of transportation rate matrix & cost converter 144 and corresponding FIG. 4 flowchart, the data fields that are transferred from the transportation management system 40 to the transportation rate matrix & cost converter 16 are shown as data fields transferred from TMS to transportation rate matrix & cost converter with general ledger codes 142.

With the aforementioned data fields present in transportation rate matrix & cost converter 16, executable code in the system standardizes, calculates and sums all transportation costs associated with the mode of transport and each port pair used by the importer. At this point, the system takes the summed amount for each port pair and divides it by the pre-established rule for cubic meters required per container in rules repository 24 to calculate a currency-based expense that is expressed as cost per cubic meter (total transportation cost divided by required CBMs per container). The standardization of different transportation costs on a per cubic meter basis is what allows for the proration and assignment of transportation expense to an item based on its weight and dimensions.

Upon executing the above instructions, the transportation rate matrix & cost converter 16 identifies an item's dimensions and weight to determine how many units of a given item are equal to one cubic meter (i.e., one cubic meter divided by the CBM equivalent of an item). The quotient of this calculation is then multiple by the cost per cubic meter to arrive at the prorated transportation cost of an item. Upon executing the instructions, the transportation component of an item's landed cost is sent to landed cost generator 20 where it is linked to a product's unit cost and customs duty amount. The result of this calculation is also sent back to product master data file 14 where it populates the field, prorated transport cost.

Turning to the rules-based functions of the transportation rate matrix & cost converter 144 found in FIG. 3 and as detailed previously, transportation rate matrix & cost converter 16 is configured to carry out a specific series of functions based on pre-determined parameters housed by port pair in the rules repository 24.

While the rules that an importer applies to the transportation rate matrix & cost converter 16 may differ based on business model, product characteristics, mode of transport and/or the complexity of customs clearance procedures, examples of parameters that can be housed in rules repository 24 include the use of shipping terms (Incoterms Rules), container size, minimum container utilization requirements and the proration of non-item-specific customs fees.

Whereas the data fields in FIG. 3 play an integral role in the execution of the first preferred embodiment, the role of general ledger (G/L) codes must be mentioned specific to two scenarios. First, the ability to identify specific transportation services coming from the transportation management system 40 to the product master data file 14 is critical to maintaining a high standard of consistency and data integrity. This is especially so when data fields are imported into the transportation rate matrix & cost converter 16, summed, prorated and sent to the landed cost generator 20 as the transportation component of a product's landed cost. Second, G/L codes are of equal importance when budgeted transportation costs housed in transportation rate matrix & cost converter 16 are compared with the actual costs that are extracted from freight forwarder & customs broker invoices 70. It is the existence of a G/L code for every transportation & customs service that allows an importer to generate the Key Performance Indicators found in business intelligence dashboard 26.

With reference now to FIG. 4, there is shown a method and exemplary operational flowchart of the data transfer, standardization of freight charges and calculation from transportation management system 40 to the transportation rate matrix & cost converter 16 and landed cost generator 20. Consistent with FIG. 3, the flowchart maps a process that begins with the importation 100 of designated fields in the transportation management system 40 to the transportation rate matrix & cost converter 16. Of special importance to this step is the transfer and confirmation of consistent and correct general ledger codes between the systems.

Once designated data fields are validated as transferred 102, 104, the transportation rate matrix & cost converter 16 segregates all transportation charges by mode of transport and port pair, and applies pre-determined, rules 106 from the rules repository 24. Upon system confirmation that port pair parameters have been applied 108, 110, the process continues with the transportation rate matrix & cost converter 16 summing all transportation charges, once again by port pair 112. Depicted in the FIG. 4 flowchart, executable code standardizes the expression of total transportation cost on a per cubic meter basis 114 while simultaneously calculating the number of units of a given item whose weight and dimensions equal one cubic meter 116.

Based on FIG. 3 and depicted in the FIG. 4 flowchart, the transportation rate matrix & cost converter 16 then prorates the item-specific transportation cost 118, confirms that all products are accounted for 120, 122 and sends the output to landed cost generator 20, where it is added to an item's unit cost and applicable customs duty 124. Upon execution of this instruction, the transportation rate matrix & cost converter 16 also sends the item-level, port pair-specific transport cost to product master data file 14 where it will populate the field, prorated transport cost 126.

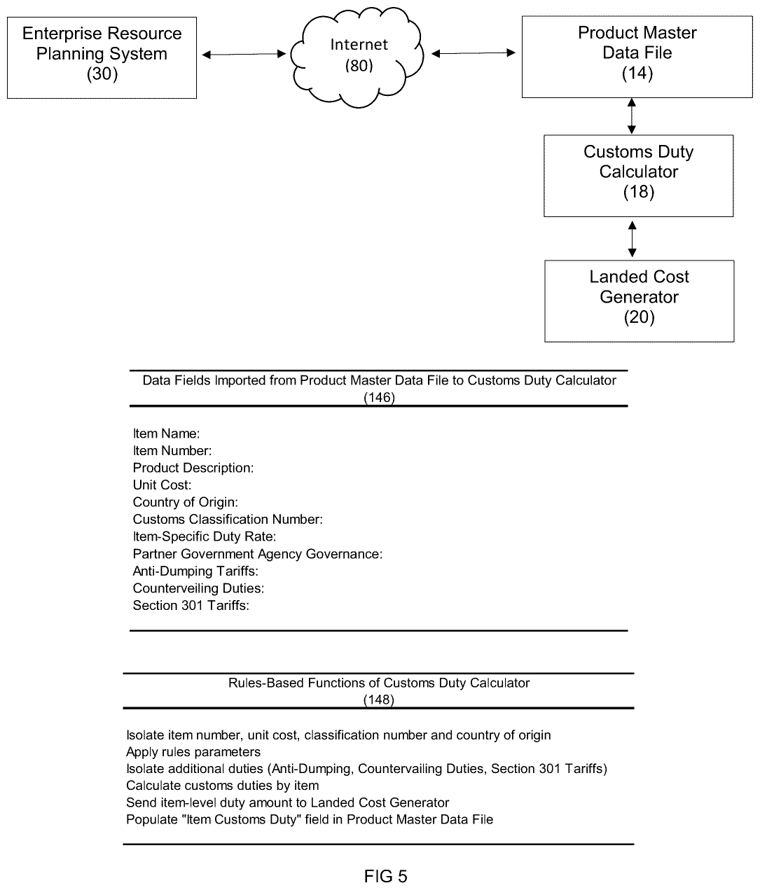

Upon completion of the prorated calculation of a product's transport cost, system platform 10 continues to the block diagram in FIG. 5 where product master data file 14, customs duty calculator 18 and landed cost generator 20 share, calculate and publish the currency-based customs duty assigned to each product in an importer's portfolio. Not unlike the calculation of an item's prorated transportation expense, customs duty calculator 18 imports item-specific data fields from product master data file 14 that enables the identification and calculation of the customs duty rate applicable to every item that a company imports. The listing of data fields required to execute the instructions of the calculation are found in FIG. 5 and are shown as data fields imported from product master data file to customs duty calculator 146.

Upon importation of the required data fields 146 into customs duty calculator 18, the calculator follows executable instructions that multiply the unit cost of an item by the percentage-based customs duty that is based on the country of origin of a product and its customs classification number. Whereas this calculation generates the basic customs duty associated with all items, customs duty calculator 18 can also calculate additional duties applied to a product such as Anti-Dumping Duties, Countervailing Duties and in the case of the U.S., Section 301 Tariffs. Calculated in the same way as a basic customs duty, customs duty calculator 18 multiplies unit cost by the corresponding percentage-based duty rate and sums all customs duties to arrive at a total figure for each item in an importer's product portfolio.

Based on the links that exist between the data fields in customs duty calculator 18 and landed cost generator 20, when the duty calculation is completed for a product, it is sent to landed cost generator 20 where it is housed at the item level and aligned with both the prorated transportation result already generated by transportation rate matrix & cost converter 16 and an item's unit cost. When the customs duty component of a product's landed cost is generated, it is also sent to product master data file 14 where the field item custom duty is populated. When all three elements of the landed cost calculation are present in landed cost generator 20, they are summed and landed cost generator 20 publishes the output of system platform 10, which is the landed cost figure for each product that a company imports from international suppliers.

As depicted in FIG. 5 and like the rules-based functions of the transportation rate matrix & cost converter 144, the rules-based functions of the customs duty calculator 148 has rules-based requirements. In this instance, rules parameters are established that address the issue of possible customs charges that are not assignable to a specific product. It is in the rules repository 24 where rules are applied to items that standardize data and costs on potential scenarios that include the proration of customs charges across multiple items included in the same customs entry, or the allocation of additional customs charges to a specific product or products.

Based on the rules-based functions of customs duty calculator 148, the essential output of customs duty calculator 18 is the total customs duty applicable to an imported product based on its country of origin and customs classification number. Based on the relational structure of system platform 10, outputs are not only stored in customs duty calculator 18, but are automatically sent to product master data file 14 where the item-specific field, item customs duty is populated.

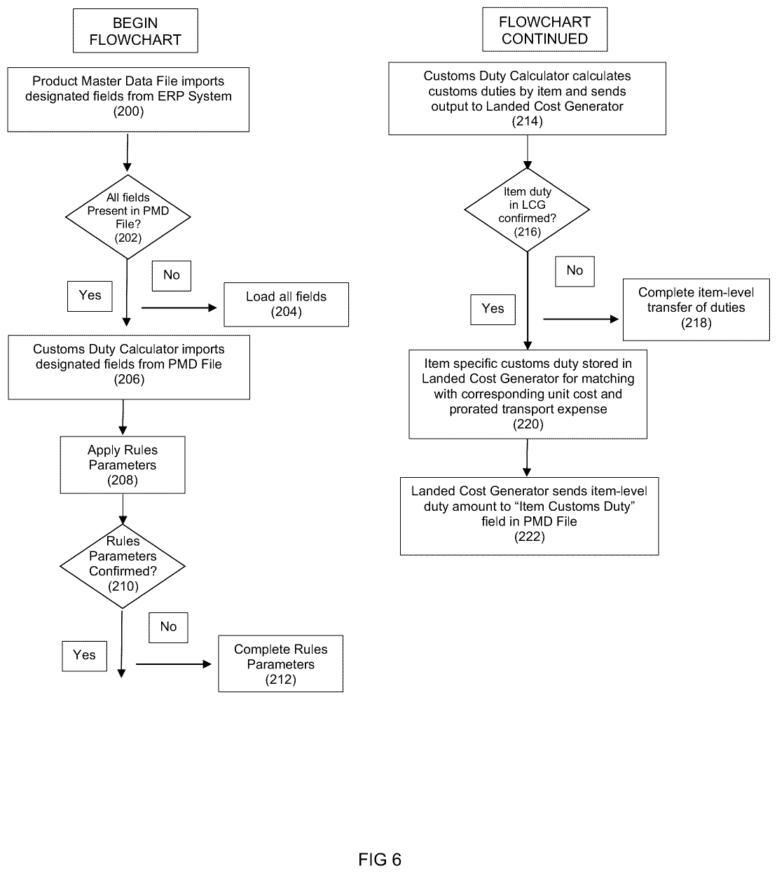

In the FIG. 6 flowchart, the process of converting data inputs into the customs duty component of a product's landed cost begins with the importation of designated data fields 200 from the importer's enterprise resource planning system 30 into product master data file 14. Integral to the flow of complete and accurate data, the system verifies that all necessary fields are present 202, 204. Customs duty calculator 18 then imports data fields 206 where rules-based parameters are applied and verified 208, 210, 212. Once rules are executed, the customs duty calculator 18 is prompted to calculate customs duty by item and send the output to the landed cost generator 214. This calculation 214 consists of multiplying the unit price of an item by the percentage-based customs duties assigned to it and/or adding per unit duties to a product. The currency-based product of this calculation represents the customs duty assigned to a product's overall landed cost.

As customs duty calculator 18 completes the generation of customs duties assignable to all items in the importer's portfolio, the system verifies that the calculation for each item has been completed 216, 218. Once verified and any omissions are corrected, item-specific customs duties are sent and stored 220 in the landed cost generator 20 for alignment with its corresponding unit cost and prorated transportation expense. This element of the process is completed when landed cost generator 20 sends item-level duty amount back to the product master data file 14 where it populates the field, item customs duty 222.

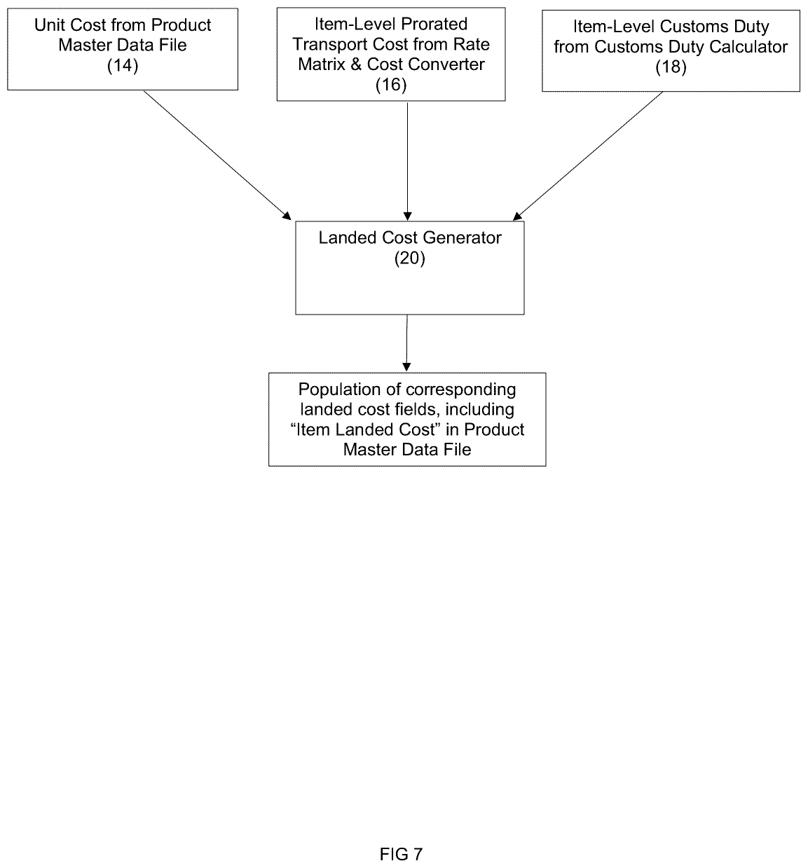

FIG. 7 is a block diagram that depicts the unification of the unit cost from product master data file 14 with item-level prorated transport cost from rate matrix & cost converter 16 and item customs duty from customs duty calculator 18. Described individually in FIGS. 1, 2, 3, 4, 5 and 6, the high-level block diagram in FIG. 7 is a holistic view of system platform 10 that unites each of the three components that make up an item's landed cost in landed cost generator 20, sums the three figures and produces the primary output of the entire system, which is the landed cost of all items imported by a company. System platform 10 then completes its essential process by sending each product's landed cost back to product master data file 14 where it is displayed for all products in the column entitled, item landed cost.

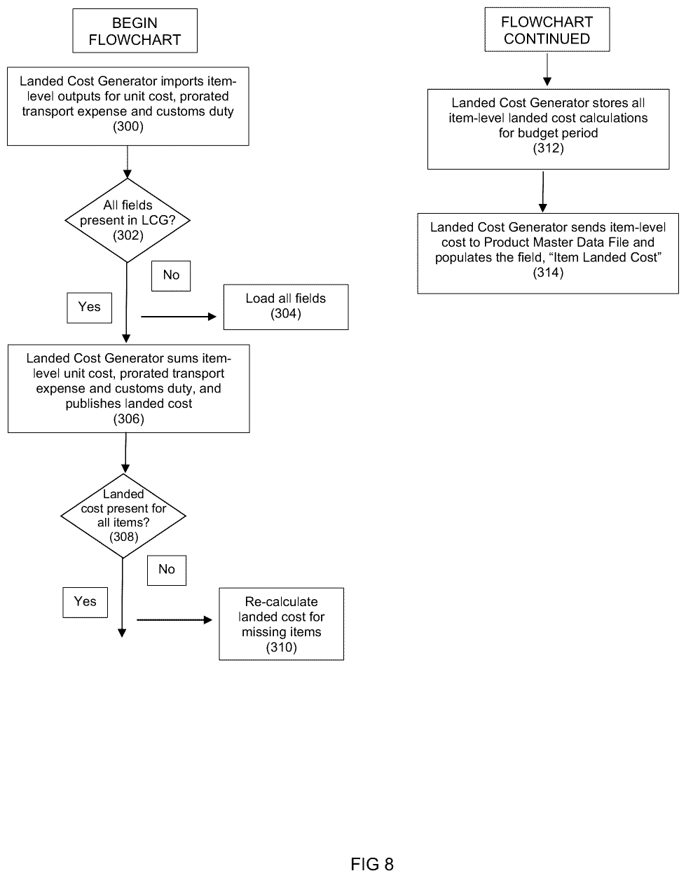

The exemplary operational flowchart in FIG. 8 maps the process of how each of the three elements of a product's landed cost are united in landed cost generator 20, summed and published as the total landed cost for an item, with the final landed cost figure being sent back to product master data file 14 and shown in the item landed cost column.

As depicted in FIG. 8, the process begins when landed cost generator 20 imports item-level outputs for unit cost, prorated transport expense and customs duty 300. As a decision point in the process map, the system verifies that each of the three fields are present and if not, flags missing fields for completion 302. Once the system confirms all fields as completed 304, the landed cost generator 20 sums item-level landed cost, prorated transport expense and customs duty, and publishes each item's landed cost 306. As a check on the system and regardless of the number of items in an importer's portfolio, the system verifies that each item has been assigned a landed cost 308, 310. Landed cost generator 20 then stores all item-level landed cost calculations for a given budget period 312, with the instructions completed when landed cost generator 20 sends each item's landed cost 314 back to product master data file 14 for final publication.

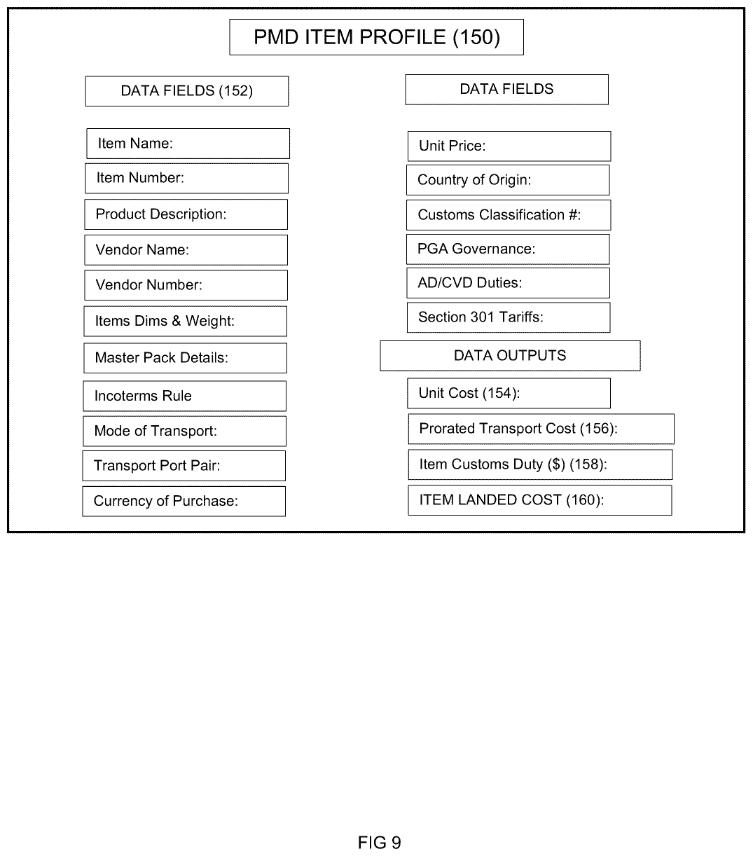

Each item in a company's product catalogue has a detailed profile in product master data file 14. Fed by the outputs of landed cost generator 20, a user interface of the product-specific data fields and outputs of product master data file 14 are displayed in FIG. 9. Originally shown in data fields transferred from user's ERP 30 to product master data file 140, the data fields needed to execute instructions in system platform 10 for all imported products are shown in FIG. 9 as the PMD ITEM PROFILE 150, 152. Of particular significance in this exemplary screen shot is the section where unit cost 154, prorated transport cost 156, item customs duty 158 and finally, item landed cost 160 are shown. Generated for all products in an importer's catalogue, this user interface exemplifies how system platform 10 executes its instructions to generate a landed cost figure at the most accurate level possible.

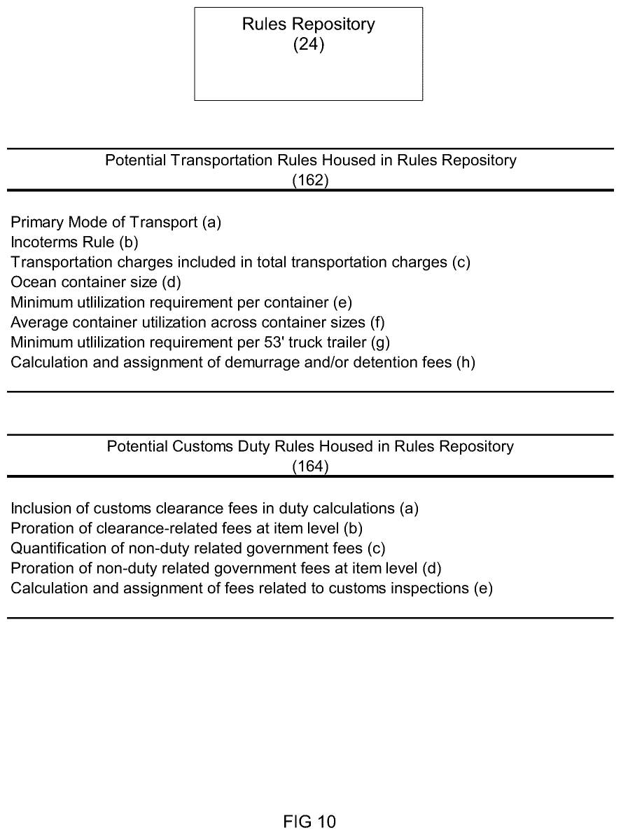

Many of the instructions-based calculations carried out by system platform 10 are subject to pre-established parameters and/or rules for the transportation and customs variables in the landed cost equation. As such, it is necessary to explain what those rules can be and how they impact the calculation of item landed cost. Whereas the rules that can be applied to a landed cost calculation will be selected based on factors that include mode of transport, applicable shipping terms, product weight and dimensions, types of customs duties levied on a product and how a customs entity assigns non-item specific duties to an entry, FIG. 10 lists the menu of variables that the importer can select from in order to generate the most accurate landed cost calculation possible.

The block diagram of rules repository 24 in FIG. 10 is broken down by potential transportation rules housed in rules repository 162 and potential customs duty rules housed in rules repository 164, each of which contains the possible rules that an importer can apply to the system platform 10.

Transportation rules 162 begins with 162a, which is the distinction required for the mode of transport. This is an important distinction because system platform 10 accommodates a plurality of modes of transport (air, ocean, rail, truck, intermodal, small parcel), each of which has its own calculations for prorating transportation costs. Incoterms Rule (shipping terms) 162b is required because shipping terms identifies the point in the physical supply chain where a vendor stops paying for transportation charges and the buyer (importer) takes over the payment of transportation charges. This rule is required to avoid the duplication of transportation charges, which in turn distort the calculation of charges in the transportation rate matrix & cost converter 16.

For the output of the transportation rate matrix & cost converter 16 to be accurate, the user 50 must determine what transportation costs will be excluded from the summing and proration of transportation costs 108, 110. It is through 162c that the importer decides where to terminate the inclusion of transportation costs in the port pair-specific summation of transportation costs 112. An example of this rule is to only include transportation costs up to a port of destination, as opposed to including transportation charges from the port of destination to an inland distribution center.

Ocean container size 162d is relevant because ocean containers come in different configurations, with differing space and weight capacities (20′, 40′, 40′ high cube and 45′). A container size must be stipulated in rules repository 24 as space/weight capacity drives the conversion of overall transportation costs to a cost per cubic meter 114. Because different container sizes determine the space and weight capacity of a given container, 162e requires that an importer designate a minimum utilization requirement per container (e.g., thirty cubic meters for a 20′ container). This stipulation assists in the standardization of the cubic meter calculation 114, while compelling the importer to make the most efficient use of each container.

If an importer uses more than one container size, user 50 has the option of prompting a rule that creates an average container utilization requirement across multiple container sizes 162f. For example, for an importer using a mix of 40′, 40′ high cube and 45′ containers, this rule allows the assignment of an average utilization requirement of sixty cubic meters.

Because transportation charges can include domestic trucking or rail services, the rules repository 24 allows the user to institute rules for the use of 53′ trailers. Should an importer decide to include domestic transportation charges in their calculation 112, 162g stipulates a minimum utilization requirement per 53′ truck/rail trailer, expressed in cubic meters.

An additional charge that applies to ocean and rail transportation is that of demurrage & detention. These are fees levied by an ocean or rail carrier for the late pick up and/or late return of a container or trailer. Because detention and demurrage only apply to those containers that are late, it is very difficult to determine what the fees will be for this type of infraction. In recognition of the importance of demurrage & detention in both ocean and rail shipping, 162h allows a user to include/not include these charges in their transportation calculations 112 and if they are included, a budgeted amount is averaged across all containers and trailers.

To bring a greater degree of accuracy to the customs duty component 214 of a landed cost calculation 306, rules repository 24 includes parameters for the customs duty elements of an item's landed cost 164. A key expense related to customs clearance is the fee that a customs broker charges to submit an entry to a customs entity. Depending on the country and pricing model of the customs broker, this can be a flat fee per entry, or include multiple charges based on the complexity of the entry itself. In either case, a customs entry can contain one item, or up to several hundred items, each with its own customs classification number. As such, the importer needs a mechanism for prorating customs clearance fees across different items, all of which may be imported multiple times during a budget period. Rule 164a requires the user to decide whether to include customs clearance fees in its calculation of customs charges 214 and if so, 164b creates the mechanism for prorating these costs across items.

In some instances, customs entities charge customs duties above and beyond normal customs tariffs. Using the U.S. as an example, U.S. Customs & Border Protection works with “Partner Government Agencies” (PGA) that include the Food & Drug Administration, the Environmental Protection Agency and Fish & Wildlife. Depending on the nature of an imported product, it may be subject to rules from a PGA that involves additional fees. 164c recognizes this possibility and allows user 50 to flag items in the product master data file 14 and assign PGA costs to them 164d.

Two other examples of non-customs duty charge from U.S. Customs & Border Protection are the Merchandise Processing Fee (MPF) and Harbor Maintenance Fee (HMF). Assessed as a percentage of the entered value of merchandise at the entry level, with both a minimum and maximum amount charged, the U.S. customs agency database 60, known as the Automated Clearing House (ACE) assigns MPF at the item level on a per entry basis. As such, this rule allows the user 50 to assign an accurate amount to all items in an importer's portfolio. In the case of Harbor Maintenance Fee (HMF), which is only applied to imports via ocean transportation, the same principles apply. Each of these scenarios is also accounted for by 164d.

Import shipments are subject to different levels of physical inspections by customs entities. Regardless of the level of inspection (e.g., partial vs. intensive exam), merchandise is often moved to a customs inspection facility where is it physically inspected by customs agents. As a part of this process, the importer is responsible for the transport of a shipment to a customs inspection site, the time customs inspectors take to review a shipment, restuffing of a container and transport back to its original location. Through rule 164e, importers can decide whether to include these charges as part of a customs calculation 208 and if so, invoke a proration methodology to do so.

Turning to the second preferred embodiment of system platform 10, the system enables the calculation of landed cost for potential new product introductions. In the first preferred embodiment, system platform 10 dealt with the calculation of landed cost for existing items in a company's product portfolio. Depending on the importer's industry and business model, a company can develop and import hundreds of new products per year. As such, a comprehensive system platform 10 must accommodate new product introductions, as well.

When calculating landed cost for a new item, the challenge is that there is no existing data in the user's enterprise resource planning software 30, or in the product master data file 14. Because the system requires specific data fields 140 to produce a landed cost calculation, it would otherwise not be possible for a user 50 to calculate the landed cost of a new product. In recognition of this need, the system features a second preferred embodiment that takes advantage of existing capabilities to generate accurate landed cost calculations for new product introductions.

Within system platform 10 there is a separate landed cost generator for new product introductions known as the new product landed cost generator 22. Whereas no data fields exist for new items in the product master data file 14, the system takes advantage of the capabilities inherent to the transportation rate matrix & cost converter 16 and the customs duty calculator 18 to execute instructions specific to the proration of transportation costs 118 and calculation of item-specific customs duties 214.

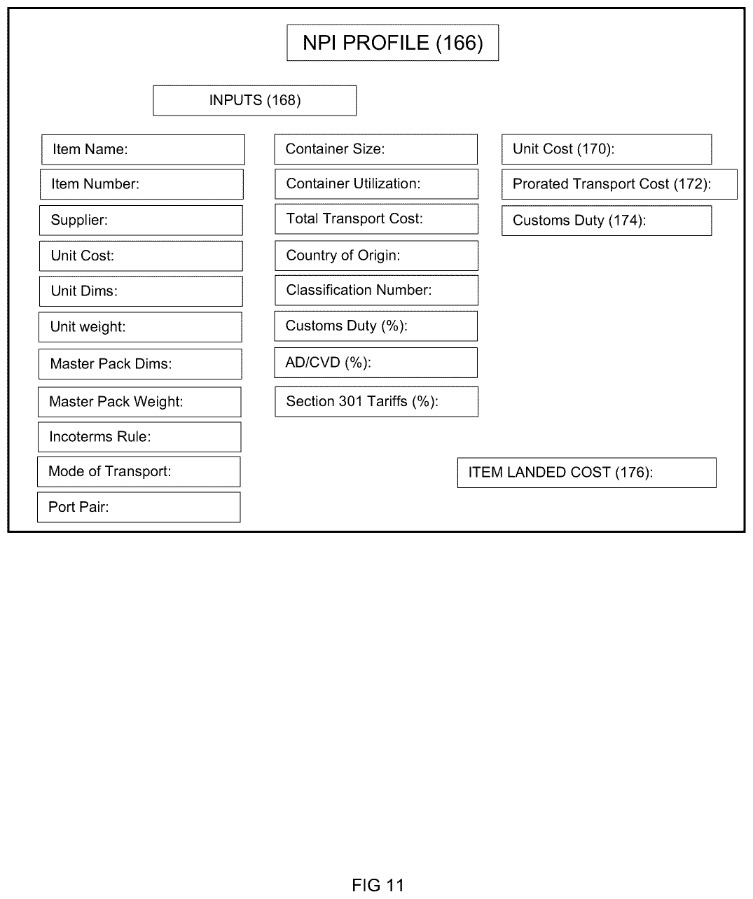

As depicted in FIG. 11, this function is achieved by inputting specific data fields into the new product introduction (NPI) graphical user interface 166, which in turn generates unit cost 170, prorated transport cost 172 and customs duty 174. The system then adds these three fields to produce the final output, which is item landed cost 176.

Shown as NPI PROFILE 166, user 50 is required to input all the data fields 168 needed to calculate both the prorated transport cost 118 and customs duties 214. Essentially the same data required to calculate item-level landed cost for existing items in an importer's product portfolio, once all data fields 168 are completed, prorated transportation costs are calculated by executing instructions identical to those described in 118.

Consistent with the overall process, item-specific customs duties are calculated using the same instructions as shown in 214. The primary difference between the landed cost calculation for existing vs. new products is that a new item's unit cost, prorated transport cost and customs duties are sent to the new product landed cost generator 22, that in turn populates the fields unit cost, prorated transport cost, customs duty and item landed cost 170, 172, 174, 176 in the new product introduction profile 166.

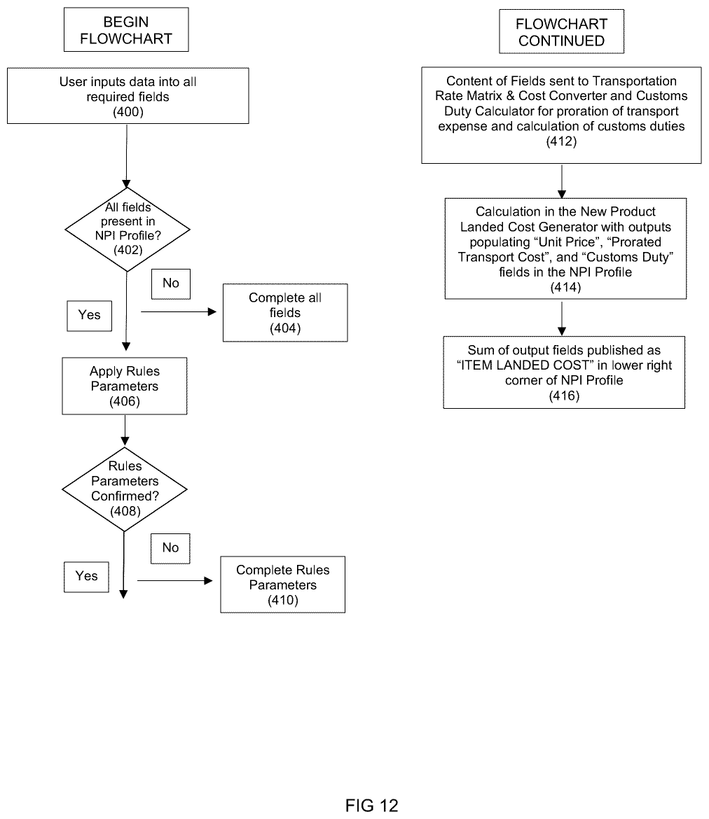

Continuing with the second preferred embodiment related to new product introductions, FIG. 12 is a flowchart that maps the process of generating a landed cost for a new product. The process requires that all data fields 400 needed to execute a landed cost calculation be present. As a checkpoint, the new product introduction profile 166 verifies that all data fields are complete 402, 404 before being able to proceed. At this point in the process, rules parameters 406 are applied and confirmed 408, 410, which include the cubic meter utilization requirement per container size.

The required data fields are simultaneously sent to the transportation rate matrix & cost converter 16 and customs duty calculator 18 where prorated transport costs 118 and customs duties 214 are calculated 412. To complete the process, the system then sends the results of the instruction-based calculations to new product introduction profile 166 where the fields unit cost 170, prorated transport cost 172, customs duty 174 and item landed cost 176 are populated 414, 416.

Within this preferred embodiment, it must be noted that an alternative embodiment exists for use by small-to-medium sized importers. Whereas most importers do employ some type of enterprise resource planning software 30 and a transportation management system 40, there are smaller companies that rely on spreadsheets, spot transportation quotes and other manual means to manage an import program. Given these methods, it is difficult for importers at the less sophisticated end of the market to take full advantage of the system and method described herein.

As such, the invention offers an alternative embodiment whereby a company can use the new product introduction profile 166 to calculate landed cost for both existing and new products. Accessed by a user via a secure internet connection 80, importers can take advantage of the capabilities of the invention by populating all required fields 168 and using the system to execution instructions for prorated transportation cost 118 and customs duty 214, that are in turn added to an item's unit cost 170 to arrive at item landed cost 176.

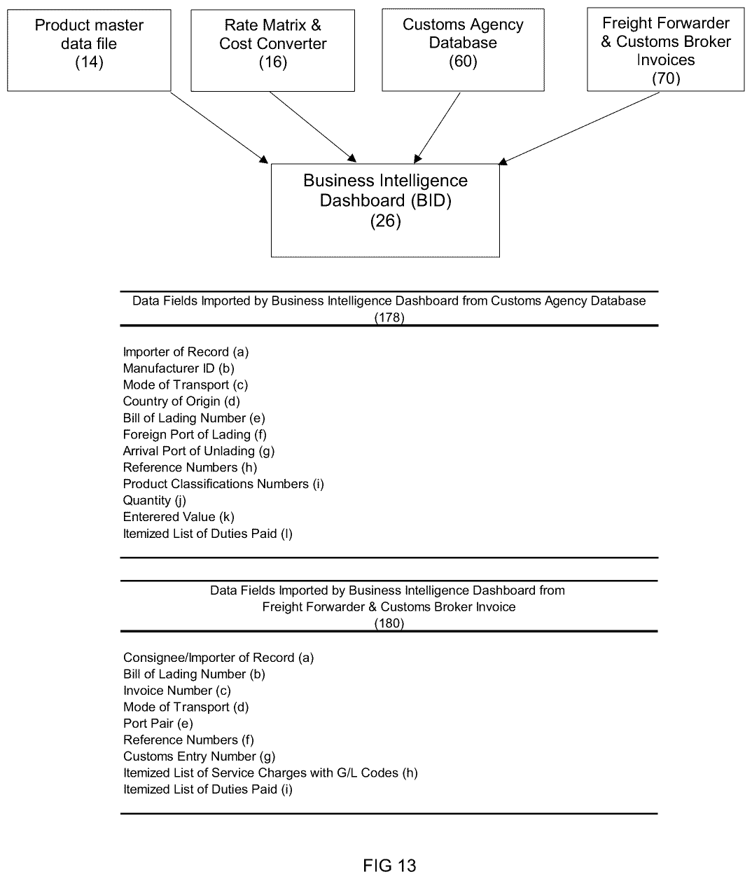

The third preferred embodiment of the invention is depicted in FIG. 13 as a business intelligence dashboard 26 that is a configurable tool that allows user 50 to mine, display, analyze and act upon data related to the unit cost, transportation expense and customs duties of every product in an importer's product portfolio. To achieve this functionality, the business intelligence dashboard 26 receives data from four sources. Based on customized configurations created by user 50, the system imports existing data from the product master data file 14 and the transportation rate matrix & cost converter 16.

Depicted in FIG. 13, the dashboard imports item-specific data from two additional external sources, a customs agency database 60 and freight forwarder & customs broker invoices 70. A customs agency database 60 is the official, electronic portal that customs entities around the world use to conduct import/export trade. As a second source of actual cost data related to unit, transportation and customs costs, freight forwarder & customs brokers invoices 70 display the charges that logistics service providers levy on importers for the inbound transportation and customs clearance of their merchandise. The fact that these two sources provide actual up-to-date data on the importation of goods is what allows for the measurement of real costs, as well as the comparison of actual expenses with what was budgeted for a given period.

Because real-time data points are housed in a country's customs agency database at the importer level 60, an importer can access said database via a secure internet connection 80. In the United States, the customs agency database is the Automated Commercial Environment and users can access the system via a private account on the ACE portal. By accessing ACE, item-level data can be mined and fed into the business intelligence dashboard 26 using a secure API connection. The data fields that a user must access to create the flexibility needed for a plurality of queries is found in data fields imported by business intelligence dashboard from customs agency database are shown in 178.

Consistent with the essence of system platform 10, the information that can be extracted from a customs agency database 60 is a function of what is mineable from underlying data sources. In the case of data fields imported by the business intelligence dashboard 26 from a customs agency database 60, there are twelve data elements that enable a plurality of queries. The Importer of Record 178a is the entity that imports merchandise and pay duties to the customs entity (U.S. Customs & Border Protection in the U.S.) and is the same party (consignee) that receives freight forwarder & customs broker invoices 70 from logistics service providers. The Manufacturer ID field 178b is a unique identification number assigned to an overseas vendor and is what allows for the isolation of import data by supplier.

The Mode of Transport 178c field allows for the segregation of imports by mode of transport, which is relevant to importers that import via more than one mode of transport. Country of origin 178d is what drives the customs duties assigned to an item and as such, allows for item-level queries based on variables that include total actual spend by country and/or suppliers. The bill of lading 178e is a key reference number because it is used for both customs entries, as well as found on the invoices sent by freight forwarders & customs brokers. The bill of lading serves as a key link between data mined from a customs agency database and transportation invoices.

Two key links between customs and transportation activities are foreign port of lading 178f and arrival port of unlading 178g. These two data fields represent the origin/destination port pairs that are integral to the calculation and publication of item-level proration of transportation costs 112, 114, 116, 118. These data fields also create a link with port pair-specific transportation charges found on freight forwarder & customs broker invoices 70. Reference number 178h is important because the importer can enter data into this field based on reference numbers of their choice that can include item numbers or purchase order numbers, which creates yet another link to data fields found throughout system platform 10.

For landed cost, one of the more essential data fields mined from a customs agency database 60 is the product classification number 178i. Along with country of origin 178d, this data field enables the determination of customs duties assigned to a product. For purposes of data mining and determining factors such as duties paid by item, or a comparison between budgeted and actual duties paid by item, this data field is irreplaceable. The quantity field 178j is of equal importance because it expresses the quantities of an item that are imported on an individual entry or throughout an entire budget period. Again, this data field allows for individual analysis, as well as for comparisons between budgeted and actual amounts imported.

An important data field in the analysis of customs related costs is the entered value 178k because it shows the actual value of imported goods on a customs entry. With access to this information, user 50 isolates and analyzes the value of imported items throughout the course of a budget period. The final data field found in 178 is the itemized list of duties paid 178l. As customs entries are prepared, it is very important that each item be shown individually in the electronic entry document. With this level of detail, user 50 can query data at the item level and ascertain how much was paid in customs duty in a single entry, or over a specified period. This data point is critical to an importer when trying to determine actual spend on customs duty by item, as well as when the user 50 wishes to compare budgeted customs duty expense to actual cost.

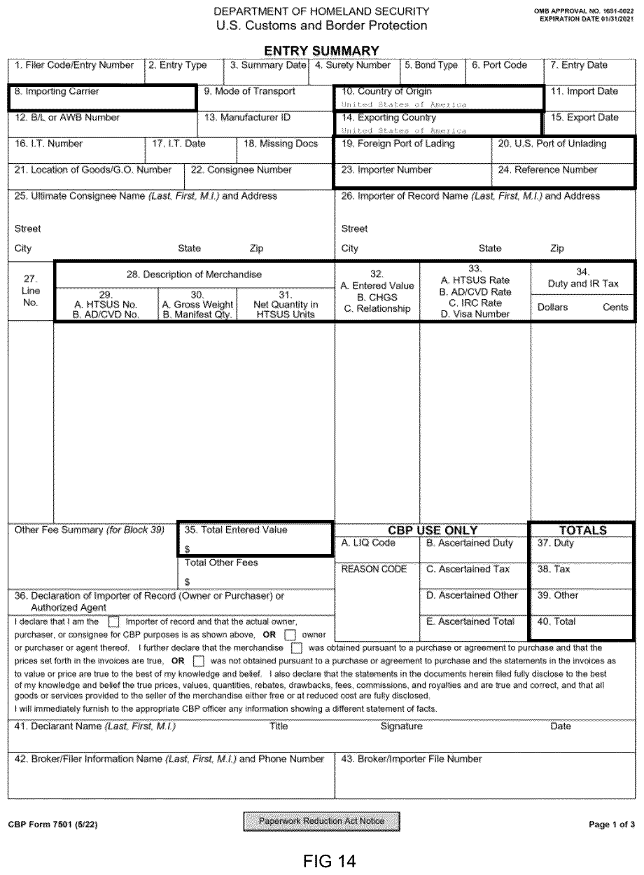

FIG. 14 is an example of an electronic customs entry used by customs entities that provides actual data as a source for the business intelligence dashboard 26. This is a U.S. example known as an Entry Summary with key data fields bolded in black. The highlighted data fields serve as the source data portrayed in 178 and are displayed here for visualization purposes. Essential to the enablement of this facet of the dashboard, a sampling of key fields includes importer of record name, bill of lading number, manufacturer ID, country of origin, customs classification number, entered value and total duties paid.

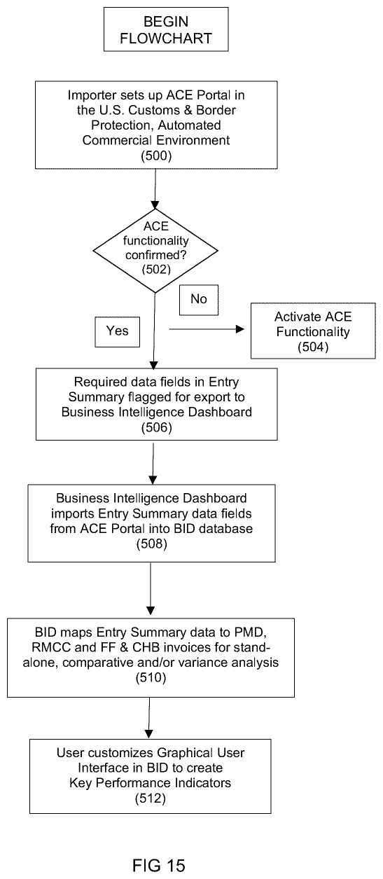

The process through which data is imported from a customs agency database 60 (U.S. example, ACE) into the business intelligence dashboard 26 is shown as a flowchart in FIG. 15. The process begins when an importer sets up an ACE Portal account in the U.S. Customs & Border Protection Automated Commercial Environment 500. Once ACE functionality is activated and confirmed 502, 504, the required data fields shown in 178 are flagged for export 506 to the business intelligence dashboard 26.

Upon flagging the required data fields that enable the analysis of actual import data, the business intelligence dashboard 26 imports entry summary data fields from the ACE Portal 508. At this point, the system maps entry summary data to corresponding fields in the product master data file 14, transportation rate matrix & cost converter 16 and freight forwarder & customs broker invoices 70. These relational links are what enable both the stand alone, as well as comparative analysis between budgeted and actual costs related to an item's landed cost 510 in the form of Key Performance Indicators 512.

Whereas the transfer of actual data from a customs agency database 60 to the business intelligence dashboard 26 enables queries for an importer to manipulate and present customs-centric information, access to live electronic feeds from freight forwarder & customs broker invoices 70 is equally empowering. Like the data fields imported by the business intelligence dashboard 26 from customs agency database 178, the key to accessing data from forwarder & broker invoices 70 is the level of detail provided at the line-item level in those invoices. This point is illustrated by returning to FIG. 13 where data fields imported by business intelligence dashboard from freight forwarder & customs broker invoices are detailed 180.

Enabled by a secure API feed, any electronic invoice from a logistics service provider that is fed into the business intelligence dashboard 26 must include the full name and address of the consignee/importer of record 180a. For purposes of creating data links in the business intelligence dashboard 26, this line item matches with the same field taken from the customs agency database 178a. The next data field that enables relational links with other elements of the system is the bill of lading number 180b. The invoice number 180c is the number of the invoice sent by the logistics service provider that allows for the breakdown of charges within each invoice.

The mode of transport field 180d is needed because it identifies shipping activities based on the type of transportation services used. The port pair field 180e is important because its links to multiple modules and executable instructions found throughout the system platform 10. Because port pairs are found in the importer's enterprise resource planning software 30, product master data file 14, and this data field is essential to the summation, proration and allocation of the transport element of an item's landed cost, 112, 114, 116, 118, the presence of this field in a logistics services electronic invoice creates the ability to execute a plurality of queries in the business intelligence dashboard 26.

A reference number field 180f in an invoice creates several ties between actual data, as well as the identification and analysis of variances between budgeted and actual spend. Powerful when the reference number matches those found in the corresponding customs field 178h, the matching of elements such as duties paid, as well as countervailing duties, anti-dumping duties or Section 301 tariffs exposes any variances between the duties charged by the customs entity and what the logistics services provider invoiced. If an invoice includes charges for customs clearance services, the customs entry number 180g also creates tiebacks to actual entries found in the customs agency database 60.

The different types of services shown on a freight forwarder & customs broker invoice that are fed into the business intelligence database 26 must be identified by a prose-based name, as well as a corresponding general ledger code 180h, 180i. Invoices that contain general ledger codes are what opens a plurality of queries that can be executed in the business intelligence dashboard 26.

Starting with an importer's transportation management system 40 and the transfer of transport-related data fields to the transportation rate matrix and cost converter 16, general ledger codes are present throughout the landed cost calculation process 100, 142. These links enable the isolation of transportation cost by service types, along with the ability to compare actual expenses with budgeted spend represents a novel capability of the business intelligence dashboard 26.

It should be noted that depending on the regulations of a country's customs entity, as well as a credit agreement between an importer and customs broker, there are instances where the customs broker will pay customs duties on the importer's behalf and then bill the importer as a pass through for the same amount. In this scenario, any charges related to customs duties on a freight forwarder & customs broker invoice 70 should list the charge by name and show a corresponding general ledger code. This level of granularity allows for queries in the dashboard by variables such as anti-dumping duties paid by item, or a list of items subject to countervailing duties.

Also, it should be noted that U.S. Customs & Border Protection gives an importer the option to pay U.S. CBP directly via what is known in the art as an ACH Payment or Automated Clearing House, as well as participating in a monthly duties billing program called, Period Monthly Statement. In these instances, there will be no line item on an invoice for customs duties and as such, actual duties paid must be extracted from the importer's ACE Portal.

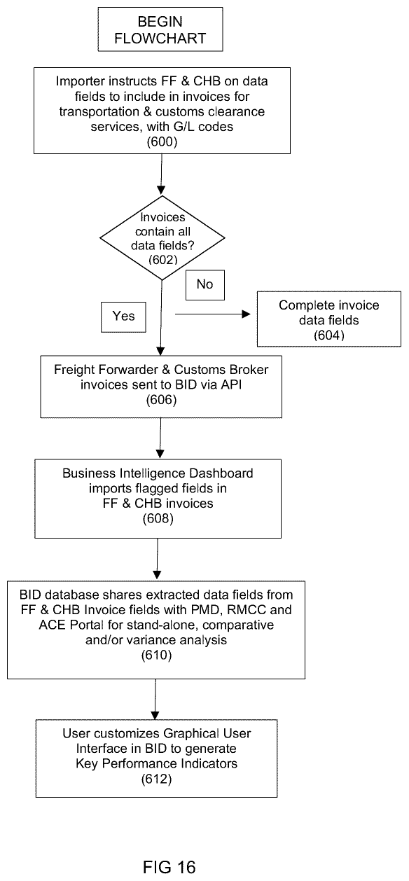

A depiction of the extraction of line-item cost details from freight forwarder & customs broker invoices 70, FIG. 16 is a flowchart that maps the steps showing how the business intelligence dashboard 26 receives data from an invoice. First, the importer provides its freight forwarder(s) & customs broker(s) with detailed instruction on how invoices for transportation and customs services must be prepared 600. In this initial step, invoices must contain a prose-based description of all services, along with each corresponding general ledger code. The system is then prompted to assure that prior to the importation of data into the business intelligence dashboard, invoices are structured in the manner instructed 602, 604.

Next, the invoice fields described in 180 are sent from the freight forwarder & customs broker invoices 70 to the dashboard and imported based on corresponding general ledger codes 606, 608. To engage in the analysis of stand-alone costs, as well as compare budgeted vs. actual spend on transportation services, the business intelligence dashboard 26 shares extracted data fields from freight forwarder & customs broker invoices 70 with the product master data file 14, transportation rate matrix & cost converter 16 and customs agency database 60 (ACE in the U.S.) for individual, comparative and/or variance analysis 610.

With all data elements present from the customs agency database 60 and freight forwarder & customs broker invoices 70, the final step in the FIG. 16 flowchart is executed when the user 50 engages with the dashboard to generate and display desired Key Performance Indicators 612.

Moving on to the user interface of the business intelligence dashboard 26, two example are provided that demonstrate the utility, novelty and flexibility of this embodiment. In a plurality of scenarios, user 50 can create customized reports, execute a search function based on key words and export results in report format.

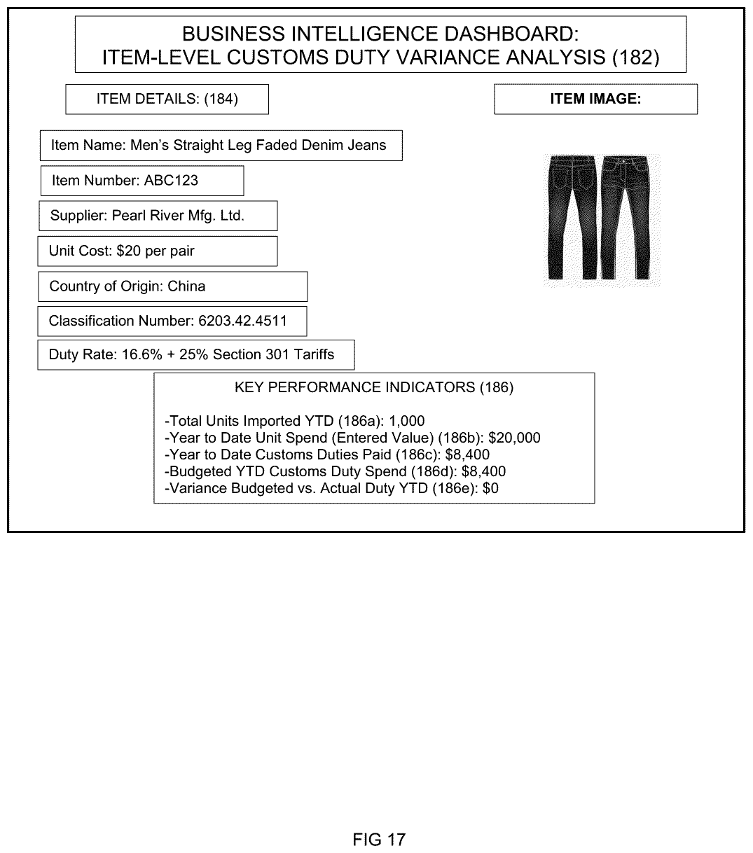

FIG. 17 is an exemplary illustration business intelligence dashboard: item-level customs duty variance analysis 182. Powered by item detail data fields 184 taken from the product master data file 14, as well as the transportation rate matrix & cost converter 16, customs agency database 60 and freight forwarder & customs broker invoices 70, this feature allows the user 50 to isolate an individual item, determine duties paid and compare between what was budgeted in customs duties for an item and what was actually paid.

In addition to seeing item-level details and an image of the product itself, there are five Key Performance Indicators (KPI) 186 generated within this view of the business intelligence dashboard 26. The first KPI is total units imported year-to-date 186a, the total of which is extracted from the customs agency database 60, as first portrayed in 178j. The second KPI is year-to-date unit spend 186b, which is also extracted from customs agency database 60, as detailed in the form of the entered value field shown in 178k. The KPI, year-to-date customs duty spend 186c is mined from customs agency database 60, while budgeted year-to-date customs duty spend 186d comes from the product master data file 14. The final KPI, variance budgeted vs. actual duty year-to-date 186e is calculated by the system comparing the budgeted customs duties figure 186d with the actual year-to-date spend in 186c, the difference of which is the variance of budgeted vs. actual customs duty spend.

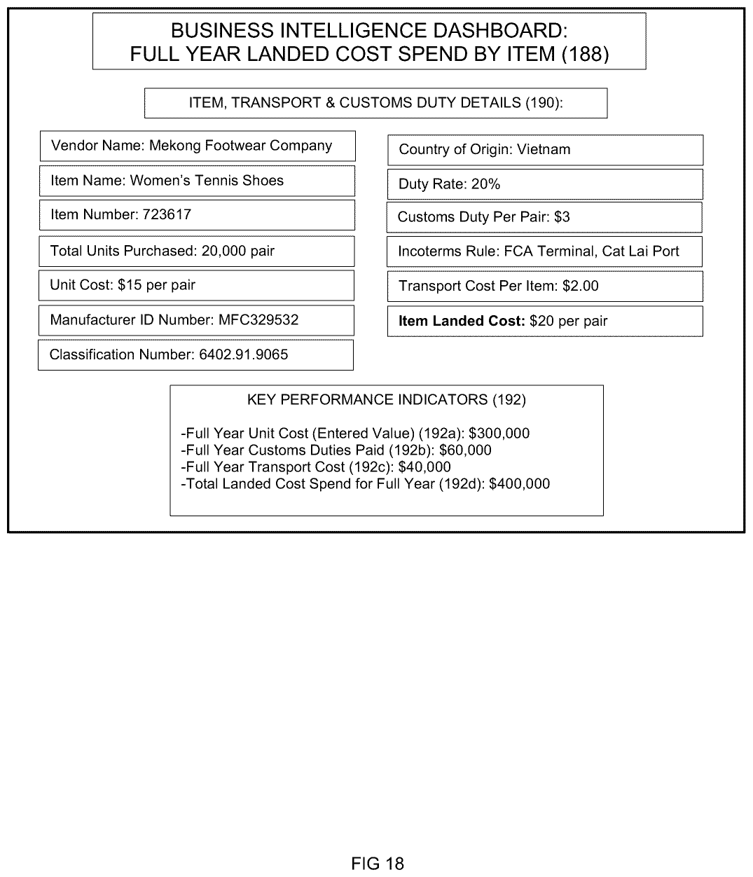

In FIG. 18, an exemplary analysis of full year landed cost spend by item 188 is conducted. Because this example focuses on a specific item's landed cost, the data fields that are shown match the data points necessary to identify and sum the item's unit cost, prorated transport cost and customs duties expense 190.

Based on access to a combination of the product master data file 14, the transportation rate matrix & cost converter 16, the customs agency database 60 and freight forwarder & customs broker invoices 70, the business intelligence dashboard 26 generates four Key Performance Indicators 192. Taken as the sum of the year-to-date entered value field presented in 178k, the first KPI, full year unit cost (entered value) 192a is calculated based on data mined from the customs agency database 60. The second KPI, full year customs duties paid 192b is also taken from customs agency database 60 as shown in 1781. The full year transport cost KPI 192c is mined from freight forwarder & customs broker invoices 70. The final output in the example is the total landed cost spend for full year 192d, which is the sum of 192a, 192b and 192c.

That which is claimed:

1. A system for calculating landed cost information comprising a unit cost for an indicated product from an identified supplier, a prorated transportation cost based on a product's weight and dimensions, and a corresponding customs duty cost from an identified country of origin, comprising:
a database management system that maintains product data, transportation cost data, customs duty data and rules data for a plurality of products, the content comprising;
a product master data file (PMD) for storing a data structure representing product details from a plurality of suppliers and countries, the PMD having a series of fields that capture individual product characteristics, wherein the fields comprise at least 1) product name 2) product number 3) supplier name 4) supplier number 5) unit price 6) currency 7) shipping term 8) product description 9) product dimensions 10) product weight 11) master pack count 12) carton dimensions 13) country of origin 14) customs classification number and 15) current customs duty;
a transportation rate matrix & cost converter module for storing transportation costs associated with different modes of transport from a plurality of origins and destinations, the transportation cost data being used to standardize, sum, prorate and assign transportation costs to individual products, wherein specific cost data is calculated for a product based on its weight and packaged dimensions;
a customs duty calculator module with access to said product details, the customs duty (tariff) data being used to calculate the customs duty on an imported product, wherein specific tariff data is isolated at the product level that is identified a corresponding customs classification number and country of origin;
a rules repository for storing and applying transportation and customs criteria, wherein selected rules are used to identify the manner in which transportation and customs expenses are assigned to a product, wherein the rules comprise at least 1) port pair 2) origin fees 3) main mode of transport fees 4) documentation fees 5) customs clearance charges 6) destination fees 7) port drayage 8) cargo insurance; 8) customs duties and;
a processor configured to:
(1) receive and store product data via an Application Programming Interface (API), requesting said data from an Enterprise Resource Planning (ERP) module for indicated products wherein product level data is stored in the product master data (PMD) file;
(2) receive and store transportation cost data via an API, requesting transfer of said data from the transportation management system (TMS) module to the transportation rate matrix and cost converter module, with said information comprising product-specific port pairs and corresponding transportation costs;
(3) access the transportation rate matrix and cost converter module to identify product transportation costs and standardize calculation of the transportation unit of measure wherein said unit of measure is expressed on a per cubic meter basis;
(4) access the transportation rate matrix and cost converter, using the cross-referenced data to identify products linked to a port pair wherein product details are flagged to determine, calculate and assign prorated transportation costs to a product based on said port pair, as well as product dimensions and weight;
(5) access the customs duty calculator to determine and assign customs duties for an indicated product, wherein tariff data is selected for a specific good based on its customs classification code, country of origin and unit price;
(6) apply rules-based logic from said rules repository to the transportation rate matrix and cost converter module, and customs duty calculator module wherein transportation and customs-specific rules are accounted for and applied to a plurality of products;
(7) transfer cross-referenced data from the transportation rate matrix and cost converter, and customs duty calculator landed cost matrix to the landed cost generator for a plurality of products, port pairs and transport modes, comprising each product's unit cost, prorated transportation expense and corresponding customs duty, wherein product-specific landed cost is computed and published for all products;
(8) receive landed cost calculations for all products from the landed cost generator into said product master data file for a plurality of products, comprising the sum of a product's unit cost, prorated transportation expense and corresponding customs duty.

2. The network-based system of claim 1, further comprising a method for determining the landed cost of a new product introduction comprising the steps of:
creating a new product introduction profile wherein the user inputs required data into fields comprising at least 1) item name 2) item number 3) unit cost 4) shipping term 5) mode of transport 6) port pair 7) container size 8) container utilization 9) product classification number 10) product country of origin 11) customs duty;
accessing said transportation rate matrix and cost converter module to determine transportation charges for the indicated port pair, using the cross-reference data in the new product introduction profile wherein product-specific details are extracted to calculate the prorated transportation costs of said new product comprising at least 1) product weight 2) product dimensions 3) master pack dimensions 4) master pack weight 5) mode of transport 6) port pair 7) container size 8) container utilization 9) total transport cost;
accessing said customs duty calculator to determine customs duties for the indicated new product, wherein the content of customs-specific fields is extracted to calculate the currency-based customs duty levied on said new product comprising at least 1) customs classification code 2) country of origin 3) unit price and 4) customs duty;
applying rules-based logic from said rules repository to the new product introduction profile, transportation rate matrix, cost converter module and customs duty calculator module wherein port pair and new product rules are accounted for and applied to a new product;
receiving cross-reference data into the new product landed cost generator for a new product, corresponding port pairs and transport modes, comprising a new product's unit cost, prorated transportation expense and corresponding customs duty, wherein the new product's landed cost is computed and published in the corresponding fields within said new product introduction profile.

3. The network-based system as defined in claim 1 further comprising a configurable business intelligence dashboard, in communication with the DBMS that:
retrieves data from the product master data file, wherein the data is displayed via a user interface as the budgeted and/or actual landed cost of an identified product;
retrieves data from the transportation rate matrix & cost converter module wherein prorated transportation costs are displayed at the product level;
receives via a secure internet connection real-time data from a customs agency database wherein data from customs entries validate the duties paid on a product or products, comprising at least 1) product description 2) net quantity 3) customs classification number 4) duty rates 5) entered value 6) country of origin 7) duties paid;
retrieves data from freight forwarder & customs broker invoices wherein actual transportation and customs-related charges paid are validated, comprising at least 1) bill of lading number 2) invoice number 3) mode of transport 4) port pair 5) reference number 6) service charges by general ledger code 7) customs entry number and 8) duties paid;
configures product-specific key performance indicators wherein the financial aspect of a product portfolio is analyzed;
computes and itemizes actual transportation and customs costs by individual product wherein said business intelligence dashboard displays figures via a user interface;
compares the budgeted transportation cost for a product with its actual cost wherein variances between budgeted and actual costs are computed;
computes and itemizes actual customs duty costs by individual product wherein said business intelligence dashboard displays figures via a user interface;
determines and displays variances between budgeted transportation and customs duty costs and actual expenses.
